(19) United States
(12) Patent Application Publication
(10) Pub. No.: US 2003/0127785 A1
(43) Pub. Date: Jul. 10, 2003

(54) Adaptive shock and vibration isolation systems

(76) Inventors: Sven K. Esche, Hoboken, NJ (US); Herb LeKuch, New York, NY (US)

Correspondence Address: Licata & Tyrrell P.C., 66 E. Main Street, Marlton, NJ, 08053, US

(21) Appl. No.: 10/253,632

(22) Filed: Sep. 23, 2002

Related U.S. Application Data
(60) Provisional application No. 60/323,868, filed on Sep. 21, 2001.

(51) Int. Cl. F16M 7/00; F16F 13/00

(52) U.S. Cl. 267/140.14; 267/140.15

(57) ABSTRACT

An adaptive isolator with a passive mount and an electromagnetic actuator is provided. The adaptive isolator is useful for vibrational mounts for equipment.

### INTRODUCTION

This application claims the benefit of U.S. Provisional Application No. 60/323,868 filed Sep. 21, 2001, which is herein incorporated by reference in its entirety.

### FIELD OF INVENTION

The present invention relates to adaptive isolators which are useful for vibration mounts for manufacturing equipment operating at varying speeds; shock and vibration mounts for equipment whose dynamic system properties are affected by environmental changes; vibration mounts for piping with varying dynamic parameters; protection against seismic events; sound attenuation in submarines; adaptive aircraft seat mounting for protection of pilots against hard landings; isolators for protection of fragile satellite payloads from take-off forces; and stabilizers for protection of air-based surveillance technology during take-off/landing and turbulent flight conditions.

### BACKGROUND OF THE INVENTION

Shocks and vibrations occur in virtually all manufacturing and engineering applications. In the overwhelming majority of cases, these vibrations lead to excessive noise, increased wear and tear and in some cases instability and failure. Accordingly, shocks and vibrations are highly undesirable and a multitude of vibration attenuation devices, referred to hereinafter as isolators, have been devised. By dissipating energy, these devices protect fragile objects from vibration or shock loads or reduce the forces transmitted to the environment by objects that themselves excite vibrations. By purposely dissipating energy, isolators either reduce the forces transmitted to the environment from equipment that excites vibrations, e.g., sheet metal transfer presses, forging presses, or protect fragile or high precision equipment from vibration or shock loads, e.g., high-precision manufacturing equipment in the semiconductor and optical industries.

U.S. Pat. Nos. 4,674,725; 4,742,998; 4,757,980; 5,174,552; 5,954,169; and 6,029,959 describe adaptive adjustment of dynamic stiffness and damping of isolators.

U.S. Pat. Nos. 4,859,817, 4,866,854, 4,942,671, 5,074,052, 5,412,880; 5,428,446, 5,179,525; 5,887,356, 5,909,939 and 6,086,283 describe coordinate measuring machines with stationary baseplates and adjustable components. U.S. Pat. No. 5,319,858 describes a touch probe with a stylus-supporting member supported with respect to a housing at six points of contact. U.S. Pat. No. 6,205,839 describes equipment for calibration of an industrial robot which has a plurality of axes of rotation, and a measuring device adapted for rotatable connection to a reference point during the calibration process. U.S. Pat. No. 5,791,843 describes a device for controlling the orbital accuracy of a work spindle. Other patents which describe measurement devices with moveable supports include: U.S. Pat. Nos. 4,777,818; 5,052,115; 5,111,590; 5,214,857; 5,428,446; 5,533,271; 5,647,136; 5,681,981; 5,720,209; and 5,767,380.

The successful development of improved vibration attenuation technologies has the potential for positively impacting a wide range of applications such as manufacturing machinery, land, air, water and space transportation, electronic and optical equipment.

The present invention provides innovative devices and methods for the adaptive attenuation of shocks and vibrations.

### SUMMARY OF THE INVENTION

An object of the present invention is to provide an adaptive vibration attenuation device comprising a passive mount and an electromagnetic actuator which regulates dynamic characteristics in response to changes in the excitation conditions.

Another object of the present invention is to provide an adaptive isolator which changes the natural circular frequency with actuator force.

Another object of the present invention is to provide an adaptive isolator which controls damping through Coulomb friction regulation.

Another object of the present invention is to provide an adaptive isolator which controls damping through temperature control of the damping medium.

### DETAILED DESCRIPTION OF THE INVENTION

The various types of isolators in existence can be grouped into passive isolators or active isolators. Passive isolators are devices with fixed system parameters that need to be tailored toward a specific application. Their design is thus determined by the dynamic mass to be supported, the type of dynamic disturbance, e.g., shock, random sinusoidal vibration; the frequency spectrum of the disturbance; the environmental conditions, e.g., temperature, humidity, atmospheric pressure, altitude; the available sway space and the desired level of attenuation. Passive isolators which have been used to reduce the forces transmitted from a vibration source to the environment are support mounts for manufacturing equipment such as presses and engine mounts in automobiles and other means of transportation. Passive isolators prevent fragile objects from damage or from being affected by surrounding events, e.g., semiconductor and optical manufacturing equipment, high precision measurement devices or simple shipping container isolators. These passive devices are typically relatively affordable, but less versatile when compared with active isolators.

Active isolators are essentially feedback control devices. The general function carried out by active isolators is to sense a disturbance and cancel or dampen the resulting motion by actively controlled actuation that is analogous but opposite in phase to the disturbance. While such active isolators often allow for favorable attenuation results they also exhibit a number of shortcomings the most significant being, high energy consumption for generating the continuous actuation.

In one embodiment, the present invention provides an adaptive shock and vibration attenuation device with significant advantages over conventional isolators that are currently commercially available. The adaptive isolators of the present invention are able to operate in shock or vibration mode and provide optimized protection to excitations of varying characteristics such as duration, amplitude, force and frequency. Adaptive shock and vibration attenuation is implemented by passive shock or vibration mounts that allow the adjustment of their dynamic characteristics in response to changes in the excitation conditions. Dynamic characteristics include stiffness and damping. In one embodiment, the mount stiffness is varied by combining a passive mount with highly nonlinear force-deflection characteristics with an electromagnetic actuator or other means. Alternatively, in other embodiments, the damping may be varied by adjusting or regulating the Coulomb friction or by varying the viscous damping through temperature control of the damping medium. These adjustments of the mount characteristics result in the shifting of the operating point or natural frequency. Non-invasive, non-contact sensors are used together with hardware or software-based signal processing to identify the excitation displacement or force signal and to generate the appropriate adjustments of the mount characteristics.

The present invention combines elements of both passive and active isolation where the circular natural frequency, ùₙ, of the system can be adaptively controlled in response to changes in excitation conditions. The approach is based on an underlying passive isolator with progressive (hard spring) or degressive (soft spring) stiffness characteristics, whose operating point along the force-deflection curve can be adaptively controlled. A convenient means for achieving shift is the application of an actuator force.

Since the circular natural frequency (ùₙ) of the isolator system is proportional to the square root of the stiffness, k, a high degree of nonlinearity in the load-deflection curve is desired in order to achieve maximum changes in the natural circular frequency of the isolator with minimal actuator force and within minimal sway space.

A shift in the operating point may be accomplished through electromagnetic forces or other means. A change in the system's circular natural frequency, ùₙ, may be achieved through controlled variation of the stiffness, k, or the damping ratio (æ). An adaptive attenuation device of the invention performs the following main functions: sensing of the impending vibration or shock signal, discerning the character and parameters of the signal, deriving a set of system parameters that optimize the attenuation performance of the isolator and employing the integrated actuator to adjust the system parameters accordingly.

In contrast to purely active isolators, the adaptive isolators of the present invention provide basic attenuation even in the case of malfunction of the active components. Active isolators require a constant supply of energy for the actuation in order to achieve total cancellation of the dynamic disturbance, while the present invention will use actuation only in short periods of special dynamic events such as temporary resonance and shocks.

The devices of the present invention also provide adaptivity or a general ability to react to changing conditions. Adaptive capabilities of these devices include, but are not limited to changes in the frequency or amplitude of dynamic disturbance, e.g., varying operating speed of a sheet metal transfer press based on the product, powering up/down of manufacturing equipment through resonance; supported dynamic mass, e.g., varying payload in a shipping container; the environmental conditions, e.g., temperature changes due to external factors or due to heat generation during equipment operation; and the passive damping properties, e.g., property changes of rubber compounds in elastomeric isolation mounts by aging or due to exposure to chemical agents.

The present invention provides adaptive isolators which are simpler and less expensive than the conventional active isolators. Adaptive isolators are more reliable, lighter, require less power for actuation, and offer basic passive protection even in the case of malfunctioning of the adaptive controller.

The present invention is further illustrated by the following, non-limiting mathematical system models.

Mathematical Model 1—System Equations for Harmonic Force and Motion Excitation

The governing equations for harmonic force and motion excitation become differential equations with coefficients k and c that depend on a control parameter p (e.g. actuator force):

$$\begin{matrix}m \ddot{x} + c ( p ) \dot{x} + k ( p ) x = {F}_{0} cos ( ω t ) & {ω}_{n} = \frac{1}{\sqrt{m}} \sqrt{k} \\ m \ddot{x} + c ( p ) \dot{x} + k ( p ) x = c ( p ) \dot{y} + k ( p ) y & y = {y}_{0} cos ( ω t )\end{matrix}$$

Mathematical Model 2—Static Behavior of Elastomeric Materials

The behavior of the elastomeric material of the underlying passive mounts can be characterized by the Mooney-Rivlin strain energy function W written in the form:

$$\begin{matrix}W = {{\sum }^{N}}_{k + 1 = 1} {{c}_{k1} ( {I}_{1} - 3 )}^{k} {( {I}_{2} - 3 )}^{1} + \frac{1}{2} {κ ( {I}_{3} - 3 )}^{2} \\ {I}_{1} = \begin{matrix}{C}_{11} & {I}_{2} = \frac{1}{2} ( {I}_{1}^{2} - {C}_{ij} {C}_{ij} ) & {I}_{3} = det {C}_{ij}\end{matrix}\end{matrix} \\$$

where cₖₗ represent up to nine constants (referred to as Mooney-Rivlin constants), κ—is the bulk modulus, Iᵢ are the invariants of the Cauchy-Green deformation tensor Cᵢⱼ and N is the highest order of terms included into the series. The coefficients cₖₗ determine the mechanical response of the material which are derived from experimental data of engineering stress versus engineering strain for various types of compression, tension and shear tests carried out over a wide range of strain values.

What is claimed is:

1. An adaptive isolator that allows the adjustment of dynamic characteristics in response to changes in the excitation conditions comprising a passive mount and an electromagnetic actuator, wherein the electromagnetic actuator adjusts stiffness of the isolator.

2. The adaptive isolator of claim 1 wherein the passive mount possesses highly nonlinear force deflection characteristics.

3. An adaptive isolator comprising a passive mount and an electromagnetic actuator wherein said adaptive isolator changes the natural circular frequency with actuator force.

4. An adaptive isolator comprising a passive mount and an electromagnetic actuator wherein said adaptive isolator changes the natural circular frequency through adjustment of damping.
